(19) United States
(12) Patent Application Publication
(10) Pub. No.: US 2002/0081987 A1
(43) Pub. Date: Jun. 27, 2002

(54) Radio communication apparatus

(75) Inventors: Hironori Yoshida, Kanagawa-ken (JP); Akira Ishikura, Kanagawa-ken (JP); Toru Mizumoto, Tokyo (JP)

Correspondence Address: BANNER & WITCOFF, 1001 G STREET N W, SUITE 1100, WASHINGTON, DC, 20001, US

(73) Assignee: Kabushiki Kaishya Toshiba, Minato-ku (JP)

(21) Appl. No.: 09/994,931

(22) Filed: Nov. 28, 2001

(30) Foreign Application Priority Data
Dec. 1, 2000 (JP) P2000-367358

(51) Int. Cl. H04M 1/00

(52) U.S. Cl. 455/277.1; 455/552; 455/553; 455/575

(57) ABSTRACT

In a radio communication apparatus, band-pass filters are provided in correspondence with a multiple-band receiver, a multiple-band transmitter and a GPS receiver, respectively. As radio frequency signals received by an external antenna on a vehicle-mounted adapter is inputted to the radio communication apparatus through the external connection terminal 22, signals in necessary frequency bands are passed by the band-pass filters so as to be inputted to the multiple-band receiver and the GPS receiver, respectively. This makes it possible for the connection terminal to be shared in radio communication by a cellular phone and in GPS reception with reception quality kept high both in the radio communication and the GPS reception to allow the number of external connection terminals to be reduced for providing further downsized and lightweight radio communication apparatus.

### RELATED APPLICATION INFORMATION

This disclosure is related to and claims priority to Japanese Patent application P2000-367358, whose contents are expressly incorporated herein by reference.

1. Field of the Invention

The present invention relates to a radio communication apparatus, and more particularly, to a radio communication apparatus using an antenna with multiple receivers or transceivers.

2. Description of the Related Art

With recently developed communication technologies and increasing communication needs, radio communication apparatuses such as cellular phones or PDAs (Personal Digital Assistants) with radio communication functions have become popular. The radio communication apparatuses, which are generally designed for operation outdoors or indoors beside a window, are affected by electromagnetic shielding. This shielding causes significant degradation in reception sensitivity of the radio communication apparatus when operated inside a vehicle. The degradation in signal quality results in a reduction in speech voice quality or a reduction of in a throughput in data transmission (for example, by a lowered signal to noise ratio).

Companies have provided vehicle-mounted antenna adaptors for connection to radio communication apparatuses. A user would have placed the radio communication apparatus in the adaptor and established a connection to an external antenna. Operation through the external antenna permitted radio communications that were similar to the quality of communications when outdoors.

Combinations of radio communication apparatuses (for example, cell phones or PDAs) with GPS (Global Positioning System) functionality have been suggested. A cellular phone having a GPS function can receive information about the cellular phone's position. Using the received position information, various benefits may be provided to the cell phone users. For example, emergency services may be dispatched to the location of the cell phone if needed. In addition, the cellular phone may transmit this information or similar information to a base station to alert it when the cellular phone should be handled by another base station.

In the case where a cellular phone having the GPS function is used in a vehicle, the cellular phone can receive quality radio communication signals when connected to the vehicle mounted antenna adaptor. However, a GPS receiver in the cellular phone cannot receive GPS signals due to the electromagnetic shielding of the vehicle. In this example, the usefulness of the GPS function of the cellular phone diminishes when used inside a vehicle.

One solution to this problem is to provide another external antenna for GPS use, similar to that which is used for cellular phones. The external antenna for GPS can provide a sufficient sensitivity in receiving GPS signals from the GPS satellite to thereby allow the location information to be obtained with high accuracy.

A cellular phone having a GPS function, however, in addition to having two external antennas, required for the GPS reception and for the cellular phone communication, must have an external connection terminal for the cellular phone communication and an external terminal for the GPS reception. This caused the cellular phone to have an increased number of external connection terminals, which prevented the cellular phone from being downsized. This requirement of separate antenna connections for a multipurpose radio communication device has been a significant barrier to downsizing.

### SUMMARY

The present invention solves at least one problem of the systems mentioned above. The present invention permits downsizing of a radio communication apparatus through, in some embodiments, minimizing external antenna adaptor interfaces. In some embodiments, a radio communication apparatus is provided with an external antenna adaptor that can be shared by radio communication transceiver(s) and GPS receiver(s) with reception quality in both kept high to reduce the number of connection terminals for allowing the radio communication apparatus to be further downsized and/or reduced in weight.

In one embodiment, a radio communication apparatus is connectable to a radio communication relay unit, where the apparatus includes a connection terminal configured to connect the radio communication apparatus to the radio communication relay unit, a first band pass filter configured to pass the first frequency band in a received radio frequency signal inputted from the connection terminal, a second band pass filter configured to pass the second frequency band in a received radio frequency signal inputted from the connection terminal, a first radio circuit configured to receive the radio frequency signal passed by the first band pass filter, and a second radio circuit configured to receive the radio frequency signal passed by the second band pass filter.

Therefore, according to the present invention, to each of the first and second radio circuits, a signal in an objective frequency band is inputted. Thus, there is no necessity for the first and second radio circuits to be provided with respective exclusive antennas, which allows one connection terminal to be shared by the first and second radio circuits. This necessitates only one set of connection terminal for connecting the radio communication apparatus to the relay unit. Therefore, no space becomes necessary in the radio communication apparatus for providing other sets of connection terminals to make it possible to provide the device as being downsized and lightweight.

In order to achieve the above object, a radio communication apparatus having first and second antennas and being connectable to a radio communication relay unit, the radio communication apparatus according to the present invention comprises a connection terminal configured to connect the radio communication apparatus to the radio communication relay unit, a first band pass filter configured to pass the first frequency band from a received radio frequency signal inputted from the connection terminal, a second band pass filter configured to pass the second frequency band from a received radio frequency signal inputted from the connection terminal, a first radio circuit configured to receive the radio frequency signal passed by the first band pass filter, a second radio circuit configured to receive the radio frequency signal passed by the second band pass filter, a controller configured to detect a connection with the radio communication relay unit, a first switch configured to switch connecting the first band pass filter to the first antenna or the connection terminal on the base of the controller detecting, a second switch configured to switch connecting the second band pass filter to the second antenna or the connection terminal on the base of the controller detecting.

Such a configuration becomes free from fear of causing interference of a radio frequency signal received by a radio communication relay unit with that received by the first or second antenna, that is, interference between signals in the same radio frequency. This can provide reception quality being kept high.

### BRIEF DESCRIPTION OF THE DRAWINGS

FIG. 1 shows a block diagram showing a functional configuration of a first embodiment of a radio communication apparatus according to the present invention;

FIG. 2 shows a perspective view showing a structure of a cellular phone as the radio communication apparatus and a vehicle-mounted adaptor shown in FIG. 1; and

FIG. 3 shows a block diagram showing a functional configuration of a second embodiment of a radio communication apparatus according to the present invention.

FIG. 4(a) shows a picture shown by a display unit 19 and FIG. 4(b) is a picture shown by a display unit 19.

FIG. 5 shows connection terminals and filters in accordance with embodiments of the present invention.

FIG. 6 shows alternative arrangement of connection terminals and filters in accordance with embodiments of the present invention.

### DETAILED DESCRIPTION OF THE EMBODIMENTS

First Embodiment

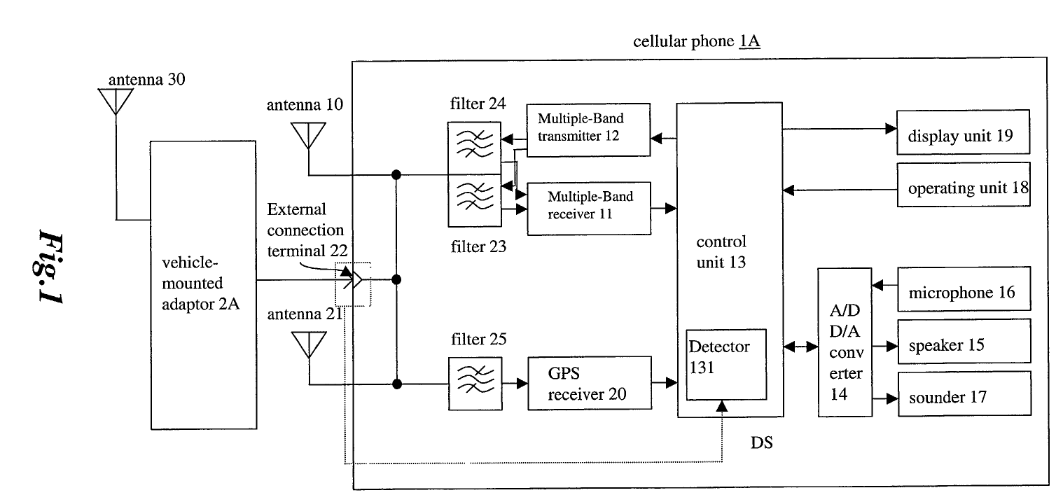

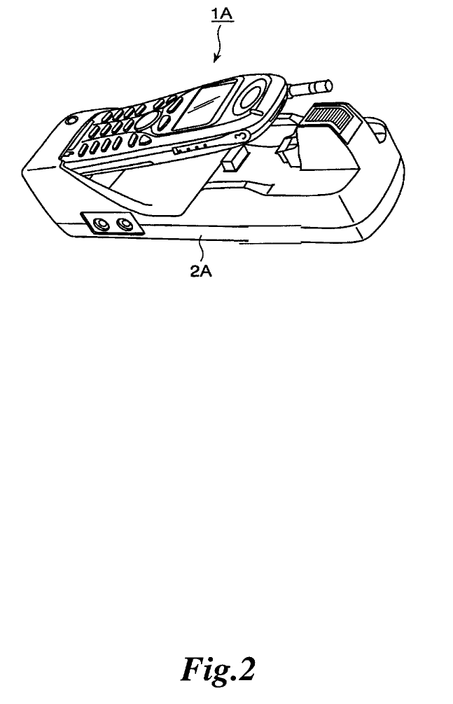

FIG. 1 is a block diagram showing a functional configuration of a multiple-band, multiple-band-capable, and/or vehicle-mounted-compatible cellular phone with a vehicle-mounted adapter. FIG. 2 is a perspective view showing the cellular phone connecting to the vehicle-mounted adapter.

The cellular phone 1A is a kind of a radio communication apparatus and the vehicle-mounted adapter is a kind of a radio communication relay unit. Other alternatives for the radio communication apparatus and radio communication relay unit are known.

In FIG. 1, a cellular phone 1A has a multiple-band receiver 11 and a multiple-band transmitter 12. The multiple-band receiver 11 can receive, for example, 900 MHz and 1.8 GHz radio frequency signals, among others. It is appreciated that the multi-band transmitter 12 and receiver 11 may include single band, dual band, tri-band and additional band capability. The multiple-band transmitter 12 can transmit 900 MHz and 1.8 GHz radio frequency signals. Transmission and reception are carried out through an antenna 10 or an external antenna 30 through a vehicle-mounted adapter 2A. The vehicle mounted adaptor 2A connects with the cellular phone 1A though an external connection terminal 22. The multiple-band receiver 11 receives a radio frequency signal in a first frequency band and the receives a radio frequency signal in a second frequency band not being in an integral multiple relations to the first frequency band.

The cellular phone 1A has a GPS (Global Positioning System) receiver 20 that receives a radio frequency signal of, for example, 1.5 GHz from GPS satellites. The reception is carried out through an antenna 21 or the external antenna 30 though the vehicle-mounted adapter 2A.

In one example, the multiple-band receiver 11 and the multiple-band transmitter 12 may carry out radio frequency signal communication with a mobile communication system employing TDMA (Time Division Multiple Access) system using the 900 MHz frequency band. Furthermore, the receiver 11 and the transmitter 12 may carry out radio frequency signal communication with a mobile communication system employing CDMA (Code Division Multiple Access) system using the 1.8 GHz frequency band. Moreover, the receiver 11 corresponding to the 1.8 GHz frequency band further combines multi-path signals in phase when applicable. Furthermore, band-pass filters 23 and 24 are provided between the multiple-band receiver 11 and the antenna 10, and between the multiple-band transmitter 12 and the antenna 10. The band-pass filter 23 allows a radio frequency signal in a 1.8 GHz frequency band to selectively pass through of radio frequency signals transmitted and received by the antenna 10 or the external antenna 30. The band-pass filter 24 allows a radio frequency signal in a 900 MHz frequency band to selectively pass through of radio signals transmitted and received by the antenna 10 or the external antenna 30.

Meanwhile, a GPS reception band-pass filter 25 is provided between the GPS receiver 20 and the antenna 21 for GPS reception. The GPS reception band-pass filter 25 allows a radio frequency signal for GPS reception in a 1.5 GHz frequency band to selectively pass through of radio signals received by the antenna 21 for GPS reception and the external antenna 30.

The cellular phone 1A further has one external connection terminal 22. The terminal 22 is provided for connecting the cellular phone 1A to the vehicle-mounted adapter 2A. Through the external connection terminal 22, signal paths of the multiple-band receiver 11 and the multiple-band transmitter 12, and a signal path of the GPS receiver 20 are connected to the external antenna 30 of the vehicle-mounted adapter 2A.

A control unit 13 comprises a microcomputer as a main control part, for example, for controlling each part of the cellular phone 1A. The control unit 13 has detector 131. The detector 131 detects an electrical connection between the cellular phone 1A and vehicle-mounted adaptor 2A through an external connection terminal 22.

A/D and D/A converter 14 converts an analog signal that is inputted from a microphone 16 to digital signal and converts digital signal that outputs to a speaker 15 or a sounder 17 to analog signal. The speaker 15 outputs the converted analog signal.

The microphone 16 outputs voices as analog signal to the converter 14. The sounder 17 outputs a reception notification sound.

An operation unit 18 may include some operation parts such as dial key pads and function keys. A display unit 19 displays information and data such as information showing an operating state of the cellular phone 1A, telephone directory data, and transmission and reception data, and the like.

An operation of the cellular phone 1A above is as follows.

An operation in a first communication mode as a cellular phone communication mode will be explained below, in which communication is carried out only with the cellular phone 1A without any connection to the vehicle-mounted adapter 2A. The antenna 10 receives a radio frequency signal from a base station.

The band-pass filter 23 or the band pass filter 24 selectively passes the 900 MHz frequency band signal or 1.8 GHz frequency band signal in the received radio frequency signal. The passed signal is inputted to the multiple-band receiver 11.

The multiple-band receiver 11 amplifies the received radio frequency signal and converts it to a signal in an intermediate frequency or a base band frequency, and demodulates the received signal to a digital signal.

In case that the multiple-band receiver 11 receives the 1.8 GHz band radio frequency signal, a RAKE combination is carried out in the receiver 11. The demodulated received signal is inputted to a control unit 13. The control unit 13 carries out an error-correction decoding processing and a voice decoding processing for the demodulated received signal for signal reproduction. The reproduced digital reception voice signal is converted to an analog signal in the converter 14 to be outputted from a speaker 15 as a voice.

While a voice of a user inputted to a microphone 16 for transmission is converted to a digital transmission voice signal in the converter 14. The converted digital transmission voice signal is inputted to the control unit 13.

The control unit 13 codes the converted digital transmission voice signal and corrects an error in the coded digital transmission voice signal. The control unit 13 generates a transmission base band signal after the coding and the correcting.

The transmission base band signal is input to the multiple-band transmitter 12. The multiple-band transmitter 12 modulates the inputted transmission base band signal and generates an intermediate frequency signal.

The generated intermediate frequency signal is converted to a radio frequency signal. The converted radio frequency signal is amplified in transmission power. Next, the amplified radio frequency signal is supplied to the antenna 10 through the band pass filter 23 or band pass filter 24 to be transmitted to a base station from the antenna 10.

A GPS signal transmitted from a GPS satellite is received by the antenna 21. The received GPS signal is inputted to the GPS receiver 20 through the GPS reception band-pass filter 25. The GPS receiver 20 demodulates the inputted GPS signal. The demodulated GPS signal is inputted to the control unit 13. The control unit 13 searches own located position based on the inputted GPS signal.

An operation in a second communication mode (a vehicle-mounted mode) is performed as follows in which the cellular phone 1A is connected to the vehicle-mounted adapter 2A, for example, for being used in a vehicle.

The cellular phone 1A is connected to the vehicle-mounted adapter 2A through the external connection terminal 22. Detector 131 detects the connection by observing the external connection terminal 22. This observation may include sensing a change in conductance, resistance, capacitance, inductance, and other known sensing techniques. External connector 22 may be or may connected to a switch that is depressed or released when connected to the vehicle mounted adaptor 2A. In the case that a detection signal DS is inputted to the detector 131, the control unit 13, in response to the input of the detection signal DS, sets the cellular phone 1A in the vehicle-mounted mode as the second communication mode.

With the cellular phone 1A set in the second communication mode, the external antenna 30 on the vehicle-mounted adapter 2A receives a radio frequency signal transmitted from a base station. The received radio frequency signal is inputted to the cellular phone 1A from the vehicle-mounted adapter 2A through the external connection terminal 22.

The band-pass filter 23 or the band pass filter 24 selectively passes the 900 MHz frequency band signal or 1.8 GHz frequency band signal in the inputted radio frequency signal. The passed signal is input to the multiple-band receiver 11.

As same in the case in the first communication mode as the cellular phone communication mode as previously described, the multiple-band receiver 11 amplifies the received radio frequency signal, converts to the intermediate frequency or base band frequency signal, and demodulates the received radio frequency signal.

900 MHz or 1.8 GHz radio frequency signal, received by the antenna 10, is also input to the multiple-band receiver 11. The received 1.8 GHz band signal is made in phase with a signal received by the external antenna 30 before being combined therewith in the multiple-band receiver 11. Therefore, even if the reception level of the radio frequency signal received by the antenna 10 is high to some extent, the radio frequency signal received by the external antenna 30 is not interfered by the radio frequency signal received by the antenna 10.

A transmission signal outputted from the control unit 13 is inputted to the multiple-band transmitter 12. As same in the case in the cellular phone communication mode as described above, the multiple-band transmitter 12 modulates the inputted transmission signal, generates an intermediate frequency signal, and converts the modulated intermediate frequency signal to a radio frequency signal. The converted frequency signal is amplified in transmission power.

The band-pass filter 24 removes unnecessary frequency band components in the amplified radio frequency signal. The removed frequency signal is inputted to the vehicle-mounted adapter 2A through the external connection terminal 22. The inputted radio frequency signal is supplied to the external antenna 30 from the vehicle-mounted adapter 2A to be transmitted to a base station. At this time, the radio frequency signal outputted from the multiple-band transmitter 12 is also supplied to the antenna 10 to be transmitted.

In addition, a GPS signal from the GPS satellite is received by the external antenna 30 of the vehicle-mounted adapter 2A. The received GPS signal is inputted to the cellular phone 1A through the external connection terminal 22. Then, the inputted GPS signal is further inputted to the GPS receiver 20 with a signal only in the GPS 1.5 GHz frequency band signal passed by the GPS reception band-pass filter 25.

As the radio frequency signal received by the external antenna 30 has various frequency bands including frequency bands used in a mobile communication system, 1.5 GHz frequency band which is used in the GPS signal is inputted to the GPS receiver 20. Therefore, the GPS receiver 20 receives a signal transmitted from the GPS satellite without being affected by radio frequency signals in other frequency bands.

As described above, in the first embodiment according to the present invention, the multiple-band receiver 11, the multiple-band transmitter 12 and the GPS receiver 20 are provided with the band-pass filter 23, the band-pass filter 24 and the GPS reception band-pass filter 25, respectively.

With the cellular phone 1A having such a configuration, the band-pass filters 23, 24 and 25 select frequency bands in the radio frequency signals received by the external antenna 30 and input the radio frequency signal in the selected frequency bands to the multiple-band receiver 11 or the GPS receiver 20.

Therefore, the multiple-band receiver 11 and the GPS receiver 20 receive high quality radio frequency signals from a base station and the GPS satellite, respectively, without any interference in other frequency bands.

The multiple-band receiver 11, the multiple-band transmitter 12, and the GPS receiver 20, respectively, share one external antenna 30 though the external connection terminal 22 for connecting the cellular phone 1A to the vehicle-mounted adapter 2A. This makes it possible to provide the cellular phone 1A as being downsized and lightweight.

Furthermore, about the radio frequency signal in 1.8 GHz band, the multiple-band receiver 11 is used for combining the radio frequency signals in phase that are received by the external antenna 30 and the antenna 10, respectively.

Therefore, even if the reception level of a signal received by the antenna 10 is high, the radio frequency signal received by the external antenna 30 is not interfered by the radio frequency signal received by the antenna 10.

Second embodiment

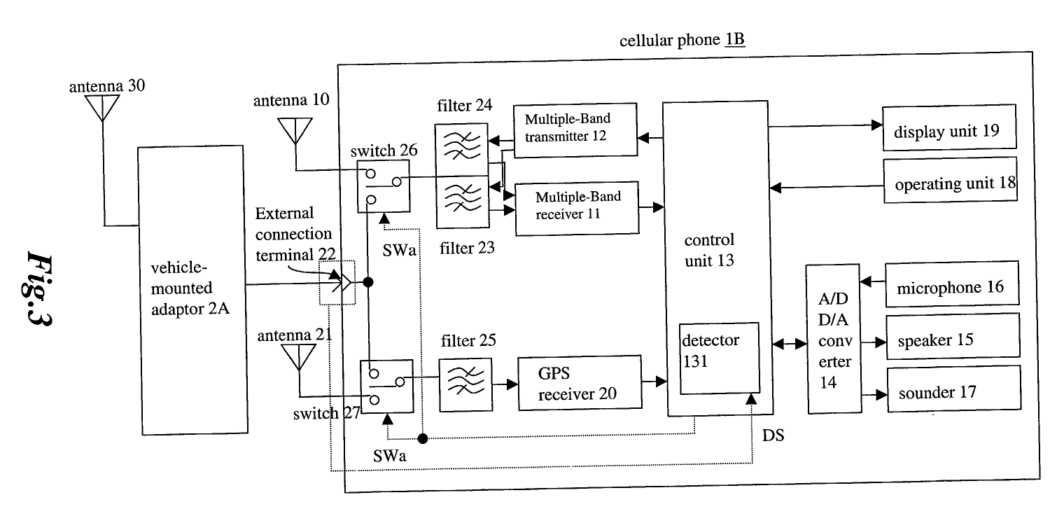

FIG. 3 is a block diagram showing a functional configuration of a vehicle-mounted-compatible cellular phone with a vehicle-mounted adapter as a second embodiment of a radio communication apparatus according to the present invention. In FIG. 2, the same constituents as those in FIG. 1 are denoted by the same reference numerals with detailed explanations for those constituents omitted.

A switch 26 is provided between the antenna 10 of a cellular phone 1B and the band-pass filters 23 and 24, a switch 27 is provided between the antenna 21 of the cellular phone 1B and the GPS reception band-pass filter 25. The switch 26 and 27 are operated by a control signal SWa from a control unit 13.

The control unit 13 has a mode decision function, and a switching control function for switching 26 and 27.

The mode decision function is for making a decision on the basis of the detection signal DS the adapter detector 131 detects as to the cellular phone 1B is in which state of a first communication mode or a second communication mode.

The first communication mode is a mode that the cellular phone 1B communicates without a connection to the vehicle-mounted adapter 2A. The second communication mode is a vehicle-mounted mode that the cellular phone 1B communicates with a connection to the vehicle-mounted adapter 2A.

The switching control function is for switching the switch 26 and switch 27 based on the result of the decision made by the above mode decision function. For the decision made as being in the first communication mode, the switch 26 is switched to the antenna 10 and switch 27 is switched to the antenna 21. While, for the decision made as being in the second communication mode, the switch 26 and the switch 27 are switched to the external connection terminal 22.

As the cellular phone 1B has such a configuration, in the case that the cellular phone 1B is set in the second communication mode, the multiple-band receiver 11 and the multiple-band transmitter are connected only to the external antenna 30 on the vehicle-mounted adapter 2A and the GPS receiver 20 is connected only to the external antenna 30.

Thus, in the second communication mode, no radio frequency signals received by the antenna 10 and 21 are inputted to the multiple-band receiver 11 and the GPS receiver 20. Instead, only the radio frequency signals received by the external antenna 30 on the vehicle-mounted adapter 2A are inputted to the receiver 11. Therefore, even if the reception level of a signal received by the antenna 10 or antenna 21 is high, the radio frequency signal received by the external antenna 30 does not interfere by the radio frequency signal received by the antenna 10 or antenna 21. Therefore, the cellular phone 1B communicates in the second communication mode in a stable fashion and receives high quality GPS signals.

Other Embodiments

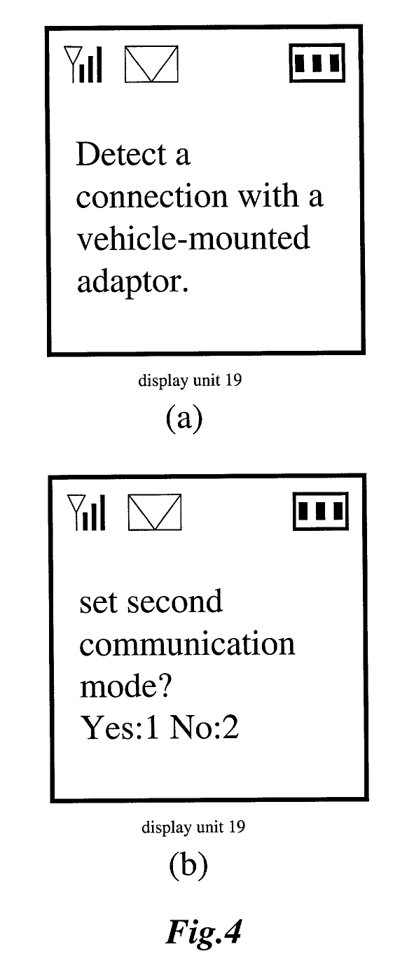

In case that adaptor detector 131 detects a connection with a vehicle-mounted adaptor 2A, control unit 13 may display a message described in FIG. 4(a) on a display unit 19. The control unit 13 indicates to display the message on the display unit 19. This message on the display unit 19 notifies a user of the connection with a vehicle-mounted adaptor 2A.

In case that adaptor detector 131 detects a connection with a vehicle-mounted adaptor 2A, control unit 13 can display a message described in FIG. 4(b) on a display unit 19. The control unit 13 indicates to display the message on the display unit 19. This message on the display unit 19 can let a user select whether second communication mode is set or not.

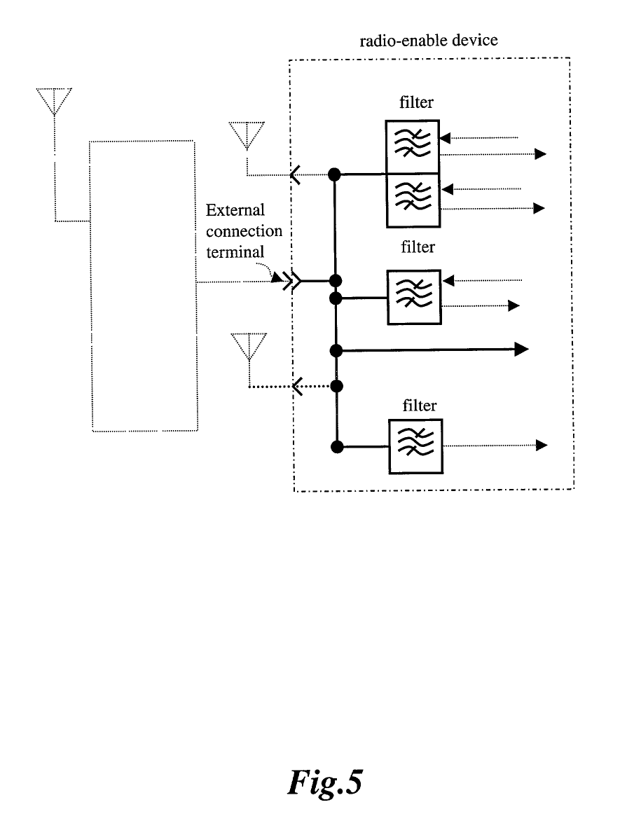

This invention is not limited to a cellular phone described in the above embodiments. For example, one embodiment includes a radio-enabled device shown in FIG. 5. The radio-enabled device is capable of having three or more filters or groupings of filters. An external connection terminal in the radio-enable device shown in FIG. 5 is also capable of being connected to a receiver or a transmitter without a filter.

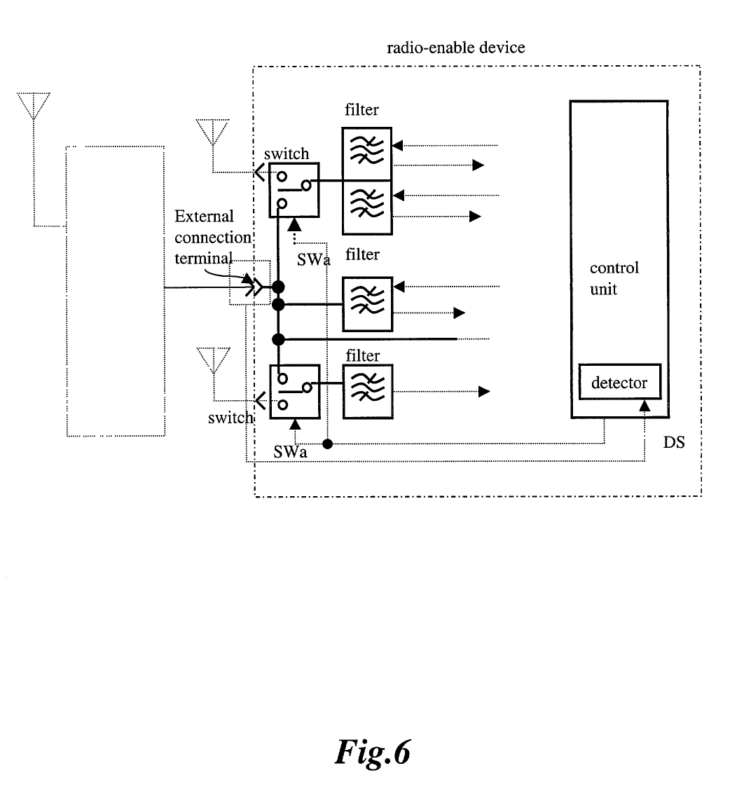

Further, another embodiment is shown in FIG. 6 in which switches of FIG. 3 are used to control signals to and from the various antennas. The radio-enabled device of FIG. 6 has similar capabilities as the radio-enable device shown in FIG. 5 with greater differentiation between received signals and control of which antenna will be used for transmission (as well as receiving).

The present invention is not limited to the above embodiments. For example, a space diversity circuit can be provided in each of the multiple-band receiver 11 and the GPS receiver 20. With this, a level of a radio frequency signal received by the external antenna 30 is compared with that received by the antenna 10 in the vehicle-mounted mode for allowing a signal with a larger level to be selected. Further, error correction circuitry maybe applied to the diversity antenna relationships to increase a received signal to noise ratio.

In the above embodiments, each of the multiple-band receivers 11, the multiple-band transmitter 12 and the GPS receiver 20 shares an external antenna 30. However, each of one single band transmitter-receiver and the GPS receiver 20 can share one external antenna 30 through the external connection terminal 22, or a plurality of single band transmitter and receivers can share the one external antenna 30 through the external connection terminal 22.

As is described in detail, in a radio communication apparatus connectable to a radio communication relay unit through a connection terminal, a configuration is provided as below. Namely, there are provided a first band pass filter and a second band pass filter correspondingly to a first radio circuit and a second radio circuit, respectively. The first radio circuit receives a radio frequency signal in a first frequency band and the second radio circuit receives a radio frequency signal in a second frequency band not being in an integral multiple relations to the first frequency band. When radio frequency signals are received and inputted from the radio communication relay unit to the radio communication apparatus through the connection terminal, the first band pass filter passes the radio frequency signal in the first frequency band of the inputted radio frequency signals and inputs the passed signal to the first radio circuit. While, the second band pass filter passes the radio frequency signal in the second frequency band of the radio frequency signals inputted from the radio communication relay unit and inputs the passed signal to the second radio circuit.

Therefore, according to the present invention, the connection terminal can be shared in radio communication and GPS reception with reception quality in both kept high. This can provide a radio communication apparatus in which the number of connection terminals is reduced to allow the device to be further downsized and lightweight.

What is claimed is:

1. A radio communication apparatus being connectable to a radio communication relay unit, the apparatus comprising:
a connection terminal configured to connect the radio communication apparatus to the radio communication relay unit;
a first band pass filter configured to pass a first frequency band in a received radio frequency signal inputted from the connection terminal;
a second band pass filter configured to pass a second frequency band in a received radio frequency signal inputted from the connection terminal;
a first radio circuit configured to receive the radio frequency signal passed by the first band pass filter; and
a second radio circuit configured to receive the radio frequency signal passed by the second band pass filter.

2. The radio communication apparatus according to claim 1, wherein the first frequency band is for communicating with a radio communicating system and the second frequency band is for receiving a GPS signal from a GPS satellite.

3. The radio communication apparatus according to the claim 1, further comprising,
a first antenna configured to receive a radio frequency signal for communicating with a radio communicating system;
a second antenna configured to receive a radio frequency signal for receive a GPS signal from a GPS satellite.

4. The radio communication apparatus according to the claim 3, wherein the first radio circuit is capable to receive a plurality of radio frequency bands for communicating with a radio communicating system.

5. The radio communication apparatus according to the claim 4, wherein the radio communicating system adapts a method of time division multiple access.

6. The radio communication apparatus according to the claim 4, wherein the radio communicating system adapts a method of code division multiple access.

7. A radio communication apparatus having first and second antennas and being connectable to a radio communication relay unit, the apparatus comprising:
a connection terminal configured to connect the radio communication apparatus to the radio communication relay unit;
a first band pass filter configured to pass the first frequency band from a received radio frequency signal inputted from the connection terminal;
a second band pass filter configured to pass the second frequency band from a received radio frequency signal inputted from the connection terminal;
a first radio circuit configured to receive the radio frequency signal passed by the first band pass filter;
a second radio circuit configured to receive the radio frequency signal passed by the second band pass filter;
a controller configured to detect a connection with the radio communication relay unit;
a first switch configured to switch connecting the first band pass filter to the first antenna or the connection terminal on the base of the controller detecting; and
a second switch configured to switch connecting the second band pass filter to the second antenna or the connection terminal on the base of the controller detecting.

8. The radio communication apparatus according to claim 7, wherein the first band pass filter is connected to the connection terminal through the first switch in case that the controller detects a connection with the radio communication relay unit.

9. The radio communication apparatus according to claim 7, wherein the first band pass filter is connected to the first antenna through the first switch in case that the controller detects no connection with the radio communication relay unit.

10. The radio communication apparatus according to claim 7, wherein the second band pass filter is connected to the connection terminal through the second switch in case that the controller detects a connection with the radio communication relay unit.

11. The radio communication apparatus according to claim 7, wherein the second band pass filter is connected to second antenna through the second switch in case that the controller detects no connection with the radio communication relay unit.

12. The radio communication apparatus according to claim 7, wherein the first frequency band is for communicating with a radio communicating system and the second frequency band is for receiving a GPS signal from a GPS satellite.

13. The radio communication apparatus according to the claim 12, wherein the first radio circuit is capable to receive a plurality of radio frequency bands for communicating with a radio communicating system.

14. The radio communication apparatus according to the claim 13, wherein the radio communicating system adapts a method of time division multiple access.

15. The radio communication apparatus according to the claim 13, wherein the radio communicating system adapts a method of code division multiple access.

16. The radio communication apparatus according to claim 7, further comprising;
a display unit configured to display information;
wherein the display unit displays a message to inform that the controller detects the connection with radio communication relay unit.

17. The radio communication apparatus according to claim 7, further comprising;
a display unit configured to display information;
wherein the display unit displays a message to confirm that the controller detects the connection with radio communication relay unit.
